(19) United States
(12) Patent Application Publication
(10) Pub. No.: US 2009/0298412 A1
(43) Pub. Date: Dec. 3, 2009

(54) Air duct outlets that produce self-oscillating air flow

(76) Inventors: Thomas F.J. Gehring, Scarborough (CA); Ireneusz Jankowski, Richmond Hill (CA); Dejan Havidic, Toronto (CA); Jeffrey A. McKerrall, Toronto (CA); Douglas Lim Hester, Scarborough (CA)

Correspondence Address: MYERS BIGEL SIBLEY & SAJOVEC, PO BOX 37428, RALEIGH, NC, 27627, US

(21) Appl. No.: 11/659,254

(22) PCT Filed: Sep. 14, 2005
(86) PCT No.: PCT/US05/32697

§ 371 Date: Oct. 2, 2008

Related U.S. Application Data
(60) Provisional application No. 60/610,723, filed on Sep. 17, 2004.

(51) Int. Cl. B60H 1/34; F24F 13/06

(52) U.S. Cl. 454/153; 454/285

(57) ABSTRACT

An air duct outlet includes a housing having spaced-apart top and bottom walls, and spaced-apart first and second side walls extending between the top and bottom walls to define an air passageway having an inlet and outlet. The side walls diverge from the inlet to the outlet such that an air stream flowing through the air passageway oscillates in a sweeping motion as the air stream exits from the outlet.

### RELATED APPLICATION

This application claims the benefit of and priority to U.S. Provisional Patent Application No. 60/610,723 filed Sep. 17, 2004, the disclosure of which is incorporated herein by reference as if set forth in its entirety.

### FIELD OF THE INVENTION

The present invention relates generally to vehicles and, more particularly, to air duct outlets utilized within vehicles.

### BACKGROUND OF THE INVENTION

Conventionally, vehicle interiors are provided with one or more air duct outlets which are connected by ducts to an outside air source and/or to a heating and/or air conditioning system that provides cooled and/or heated air. Because it is generally desirable for vehicle occupants to be able to adjust the direction of air flow within a vehicle interior, air duct outlets are typically provided with adjustable vanes or louvers. In addition, air duct outlets may be provided with dampers for allowing vehicle occupants to control the amount of air flowing therethrough.

Conventional air duct outlets utilize one or more sets of louvers to mechanically redirect air streams. While this technology is proven and successful, the louver assemblies can be complex and expensive to manufacture. In addition, conventional air duct outlets typically provide an air stream deflection range up to only about 90° (i.e., −45° to +45° relative to a centerline of the air duct outlet). Deflection ranges in excess of ±45° typically result in large pressure drops and lower air flow rates, which are undesirable.

In addition, air duct outlets are conventionally designed to allow the passage of a large amount of air so that the cabin of a vehicle can be cooled/heated as rapidly as possible. However, passengers typically can only tolerate relatively high airflow rates for a limited duration before starting to feel uncomfortable. This problem has been addressed by the use of oscillating air duct outlets wherein the direction of airflow oscillates back and forth such that a passenger experiences direct airflow only for limited durations. For example, the Mazda 626 automobile incorporates an oscillating air duct outlet. This air duct outlet uses a small, dc motor (geared down to low rotational speed) to drive a crank which, through a shaft, mechanically moves air-directing louvers back and forth in an oscillating pattern, thereby imparting a sweeping motion to an air stream.

Unfortunately, the use of motors and associated rotational linkages to generate oscillating air stream motion can be somewhat complicated and expensive. Vehicle manufacturers are continuously seeking components, such as air duct outlets, that have enhanced functionality (such as oscillation capability) and durability, yet are cost effective to manufacture. Vehicle manufacturers are also continuously seeking components, such as air duct outlets, that can enhance styling within a vehicle, yet remain functional and economical.

### SUMMARY OF THE INVENTION

In view of the above discussion, an air duct outlet, according to embodiments of the present invention, includes a housing having spaced-apart top and bottom walls, and spaced-apart first and second side walls extending between the top and bottom walls to define an air passageway having an inlet and outlet. The side walls diverge from the inlet to the outlet such that an air stream flowing through the air passageway oscillates in a sweeping motion as the air stream exits from the outlet. Embodiments of the present invention provide an inexpensive, uncomplicated way of oscillating air flow from air vents. Embodiments of the present invention also allow for air stream deflection ranges in excess of ±45°.

### BRIEF DESCRIPTION OF THE DRAWINGS

The accompanying drawings, which form a part of the specification, illustrate embodiments of the present invention. The drawings and description together serve to fully explain the invention.

FIG. 1 is a front, perspective view of an air duct outlet, according to embodiments of the present invention, in a flush-mounted position relative to an instrument panel of a vehicle.

FIG. 2 is a front elevation view of a housing of the air duct outlet of FIG. 1, according to embodiments of the present invention.

FIGS. 3-6 are section views of the air duct outlet of FIG. 2, taken along lines 3-3 and illustrate the oscillation of an air stream flowing through the air duct outlet of FIG. 2.

### DETAILED DESCRIPTION OF THE INVENTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention.

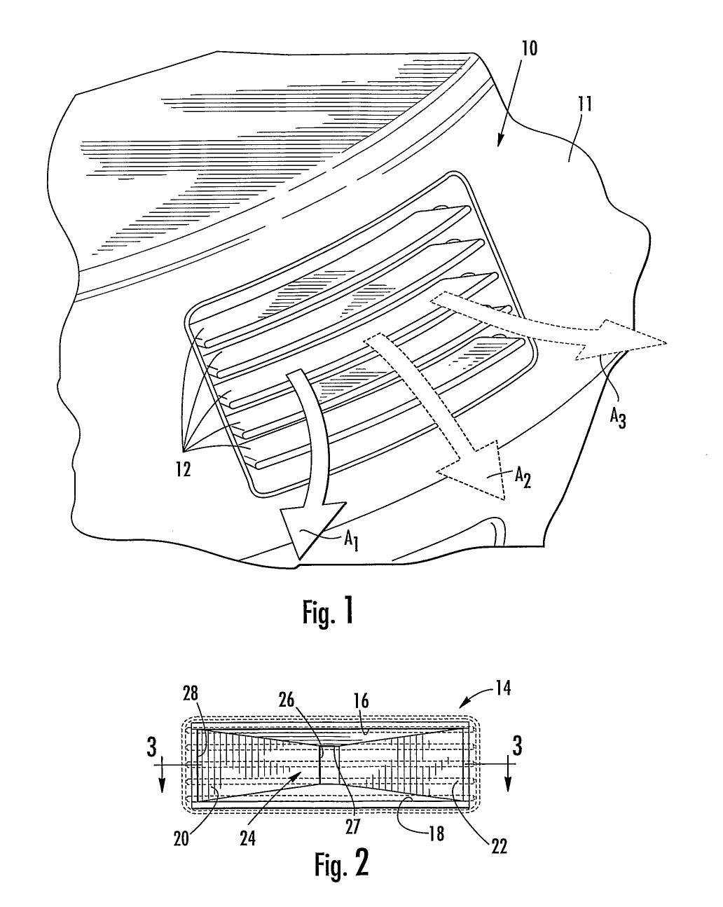

Referring to FIGS. 1-6, an air duct outlet 10, that imparts a sweeping motion to an air stream, according to embodiments of the present invention, is illustrated. The illustrated air duct outlet 10 is designed for use within the interior compartments of vehicles, such as automobiles, trucks, trains, boats, aircraft, and the like. However, it is understood that air duct outlets according to embodiments of the present invention may be utilized in various environments (e.g., in homes and offices) and are not limited only to use in vehicles.

In FIG. 1, air duct outlet 10 is installed within the instrument panel 11 of a vehicle. Arrows A₁,A₂,A₃ indicate the range of directions of an air stream exiting the air duct outlet 10 in a sweeping motion. In other words, the air duct outlet 10 causes an air stream to sweep from A₁ to A₂ to A₃ and then back from A₃ to A₂ to A₁ in repeating fashion.

The illustrated air duct outlet 10 includes a plurality of generally horizontal vanes or louvers 12 that allow a user to adjust up and down directions of a sweeping air stream exiting from the air duct outlet 10. Embodiments of the present invention are not limited to the illustrated louvers 12. Louvers of various shapes, sizes and orientation can be utilized in accordance with embodiments of the present invention. Moreover, embodiments of the present invention do not require louvers.

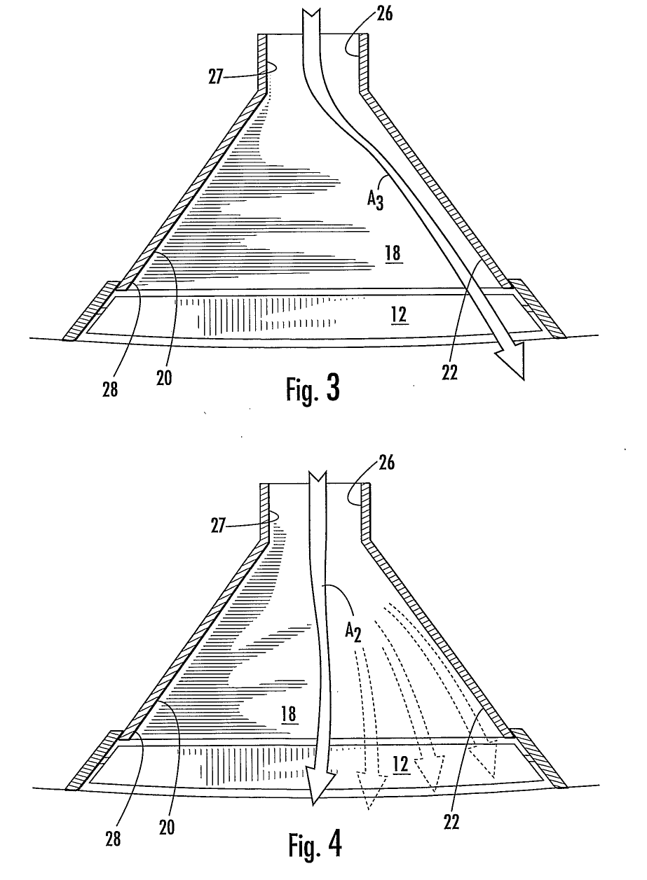

Referring to FIG. 2, the illustrated air duct outlet 10 includes a housing 14 having spaced-apart top and bottom walls 16,18, and spaced-apart, diverging first and second side walls 20,22. The side walls 20, 22 extend between the top and bottom walls 16,18 to define an air passageway, 24 that has an inlet 26, and outlet 28, and a throat region 27 downstream from the inlet 26, as illustrated. In the illustrated embodiment, the side walls 20,22 have a generally linear configuration and diverge in a downstream direction (i.e., diverge from the throat region 27 toward the outlet 28) to give the air passageway 24 a flared, V-shaped configuration.

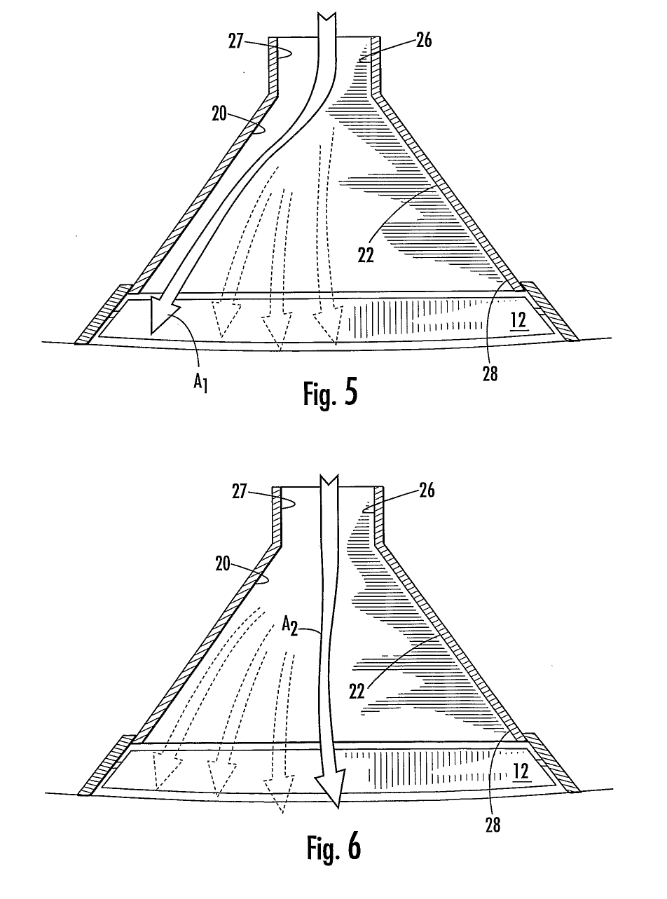

The V-shaped air passageway 24 causes an air stream flowing from an air source (not shown) upstream from the inlet 26 to the outlet 28 to oscillate in a repeating, sweeping motion as illustrated in FIG. 1. The oscillating motion of an air stream may be periodic or aperiodic. Air flowing through the V-shaped passageway adheres to one of the side walls 20,22 for a brief period of time and then jumps to the other one of the side walls 20,22 and adheres to that wall for a brief period of time. This is illustrated in FIGS. 3-6.

The side walls 20,22 may be oriented relative to one another in any of various angles without limitation. For example, side walls 20,22 may be oriented greater than about 90° relative to one another or less than or equal to 90° relative to one another. Side walls 20,22 may be oriented relative to one another within any of various ranges, for example, between about 30° and 90°, between about 30° and 60°, between about 30° and 45°, etc.

In FIG. 3, an air stream is flowing through the passageway 24 and is adhered to side wall 22 as indicated by arrow A₃. In FIG. 4, the air stream is moving toward the other side wall 20 and has a direction as indicated by arrow A₂. In FIG. 5, the air stream has moved completely to the other side wall 22 as indicated by arrow A₁. In FIG. 6, the air stream is moving back toward side wall 22 and has a direction as indicated by arrow A₂. This movement of the air stream from wall to wall creates a sweeping motion. The adherence by an air stream to one side wall and then another for brief periods of time is known as a bi-stable state since there are two stable positions that the air stream can follow (i.e., left side or right side of the air passageway 24).

The frequency of a sweeping pattern can be achieved by adjusting shapes and/or configurations of the side walls 20,22 and/or by adjusting the shapes and sizes of air passageway inlet 26 and outlet 28. The air duct outlet housing 14 and the various components thereof, can be formed from various materials without limitation.

The flared configuration of the air passageway 24 causes the air stream to adhere to the side walls 20,22 as a result of the “Coanda effect.” As known to those skilled in the art, the Coanda effect is the tendency for a moving fluid (either liquid or gas) to attach itself to a surface and flow along the surface. As a fluid moves across a surface, a certain amount of friction occurs between the surface and the fluid, which tends to slow down the fluid as it moves across the surface. This resistance to flow tends to pull the fluid towards the surface, making it adhere to the surface, even as it bends around corners.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. An air duct outlet, comprising:
a housing comprising spaced-apart top and bottom walls, and spaced-apart first and second side walls extending between the top and bottom walls to define a V-shaped air passageway having an inlet and outlet, wherein the first and second side walls are substantially linear, wherein the first and second side walls are oriented relative to one another at an angle of less than forty-five degrees (45°), wherein the side walls diverge from the inlet to the outlet, and wherein the V-shaped configuration causes an air stream flowing through the air passageway to oscillates in a sweeping motion as the air stream exits from the outlet.

2. (canceled)

3. (canceled)

4. The air duct outlet of claim 1, wherein the first and second side walls are oriented relative to one another at an angle of less than or equal to about thirty degrees (30°).

5. (canceled)

6. (canceled)

7. The air duct outlet of claim 1, wherein the top and bottom walls are in substantially parallel spaced-apart relationship.

8. The air duct outlet of claim 1, wherein the air passageway comprises a throat region between the inlet and outlet, and wherein the first and second side walls are in substantially parallel spaced-apart relationship in the throat region.

9-14. (canceled)

15. A vehicle, comprising:
an instrument panel; and
an air duct outlet disposed within the instrument panel, wherein the air duct outlet receives air from an air source and imparts a sweeping motion to the air stream as the air stream exits from the air duct outlet, wherein the air duct outlet comprises a housing comprising spaced-apart top and bottom walls, spaced-apart first and second side walls extending between the top and bottom walls to define a V-shaped air passageway having an inlet and outlet, wherein the first and second side walls are substantially linear, wherein the first and second side walls are oriented relative to one another at an angle of less than forty-five degrees (45°), and wherein the side walls diverge from the inlet to the outlet.

16. (canceled)

17. (canceled)

18. The vehicle of claim 15, wherein the first and second side walls are oriented relative to one another at an angle of less than or equal to about thirty degrees (30°).

19. (canceled)

20. (canceled)

21. The vehicle of claim 15, wherein the top and bottom walls are in substantially parallel spaced-apart relationship.

22. The vehicle of claim 15, wherein the air passageway comprises a throat region between the inlet and outlet, and wherein the first and second side walls are in substantially parallel spaced-apart relationship in the throat region.

23-28. (canceled)

29. A method of producing an oscillating air flow, comprising forcing air through an air duct outlet, wherein the air duct outlet has a housing with spaced-apart top and bottom walls, and spaced-apart first and second side walls extending between the top and bottom walls to define a V-shaped air passageway having an inlet and outlet, wherein the first and second side walls are substantially linear, wherein the first and second side walls are oriented relative to one another at an angle of less than forty-five degrees (45°), wherein the side walls diverge from the inlet to the outlet, and wherein the V-shaped configuration causes the air stream flowing through the air passageway to oscillate in a sweeping motion as the air stream exits from the outlet.

30. The method of claim 29, wherein the first and second side walls are oriented relative to one another at an angle of less than or equal to about thirty degrees (30°).

31. The method of claim 29, wherein the top and bottom walls are in substantially parallel spaced-apart relationship.

32. The method of claim 29, wherein the air passageway comprises a throat region between the inlet and outlet, and wherein the first and second side walls are in substantially parallel spaced-apart relationship in the throat region.
